(19) United States
(12) Patent Application Publication
(10) Pub. No.: US 2021/0019782 A1
(43) Pub. Date: Jan. 21, 2021

(54) METHOD, SYSTEM AND NON-TRANSITORY COMPUTER-READABLE RECORDING MEDIUM FOR CONTROLLING FLOW OF ADVERTISING CONTENTS BASED ON VIDEO CHAT

(71) Applicant: SMOOTHY INC., Seoul (KR)

(72) Inventors: Hyun Geun JO, Yongin-si (KR); Deok Won KIM, Bucheon-si (KR)

(73) Assignee: Smoothy Inc., Seoul (KR)

(21) Appl. No.: 16/081,731

(22) PCT Filed: Aug. 24, 2018
(86) PCT No.: PCT/KR2018/009838

§ 371 Date: Sep. 6, 2018

(30) Foreign Application Priority Data
Dec. 28, 2017 (KR) 10-2017-0183010

(51) Int. Cl. G06Q 30/02; G06K 9/00; H04N 7/14; H04N 7/15

(52) U.S. Cl. CPC G06Q 30/0245; G06K 9/00302; H04N 7/152; G06Q 30/0277; H04N 7/141

(57) ABSTRACT

According to an aspect of the present invention, there is provided a method for controlling a flow of advertising contents on the basis of a video chat, the method including measuring a positive response level of at least one talker among two or more talkers about an advertising content being provided to the two or more talkers on the basis of information on interaction among the two or more talkers participating in a video chat, and dynamically controlling a flow of advertising contents to be provided to the at least one talker on the basis of the positive response level.

### CROSS-REFERENCE TO RELATED APPLICATION

This application is a national phase of International Application No. PCT/KR2018/009838 filed on Aug. 24, 2018, which claims priority to and the benefit of Korean Patent Application No. 2017-183010, filed on Dec. 28, 2017, the disclosure of which is incorporated herein by reference in its entirety.

### BACKGROUND

### 1. Field of the Invention

The present invention relates to a method, a system, and a non-transitory computer-readable medium for controlling a flow of advertising contents based on a video chat.

### 2. Discussion of Related Art

As the Internet and video technologies evolve, people are increasing using a vivid video chat away from a conventional voice call or a conventional text chat. Further, the market for advertising using such a video chat is continuously growing. In addition, various studies are being conducted on how to efficiently provide advertisements to chat participants based on a video chat.

An example of the related art includes a method in which, when a chat service providing server receives a chat service request from a user terminal, the chat service providing server provides one of a plurality of chat rooms to the user terminal and configures an advertising content as a layer separated from the chat room, thereby displaying the advertising content to be overlapped with the chat room of the user terminal.

Another example of the related art includes an advertisement-added chat system including an advertisement server configured to load advertising contents of an advertisement category selected from a user terminal, and the user terminal configured to display advertising contents matching words of a chat message in addition to the chat message.

However, according to the above-described related art and the existing conventional techniques, only advertisements corresponding to personal information of talkers or words appearing during a chat among the talkers are provided without considering how the talkers participating in the chat response the provided advertisements, and once advertisements, which will be provided to talkers, are determined, even when the talkers take no interest in the advertisements, the advertisements are provided until being terminated.

Therefore, the present inventors propose a technique for measuring a positive response level of each of talkers about advertising contents using information on interaction between the talkers and dynamically controlling a flow of the advertising contents according to the positive response levels.

### SUMMARY OF THE INVENTION

An objective of the present invention is to resolve all the above-described problems of the related art.

Further, another object of the present invention is to control a flow of advertising contents by allowing talkers to naturally communicate with each other without clicking or typing.

Furthermore, still another object of the present invention is to maximize the advertising efficiency and effect by dynamically controlling the flow of the advertising contents on the basis of the information on the interaction between the talkers.

Additionally, yet another objective of the present invention is to resolve repulsion or a privacy problem for image acquisition by naturally acquiring a facial expression or gaze information of a talker during a video chat.

A typical configuration of the present invention for achieving the above-described objectives is as follows.

According to an aspect of the present invention, there is provided a method for controlling a flow of advertising contents on the basis of a video chat, the method including measuring a positive response level of at least one talker among two or more talkers about an advertising content being provided to the two or more talkers on the basis of information on interaction among the two or more talkers participating in a video chat, and dynamically controlling a flow of advertising contents to be provided to the at least one talker on the basis of the positive response level.

According to another aspect of the present invention, there is provided a system for controlling a flow of advertising contents on the basis of a video chat, the system including an advertising response measurement unit configured to measure a positive response level of at least one talker among two or more talkers about an advertising content being provided to the two or more talkers on the basis of information on interaction among the two or more talkers participating in a video chat, and an advertising flow management unit configured to dynamically control a flow of advertising contents to be provided to the at least one talker on the basis of the positive response level.

In addition to the foregoing, there are provided another method for implementing the present invention, another system, and a non-transitory computer-readable recording medium for recording a computer program for performing another method.

### BRIEF DESCRIPTION OF THE DRAWINGS

FIG. 1 is a diagram illustrating a schematic configuration of an overall system for controlling a flow of advertising contents on the basis of a video chat according to one embodiment of the present invention.

FIG. 2 is a detailed diagram illustrating an internal configuration of an advertising flow control system according to one embodiment of the present invention.

FIG. 3 is a diagram exemplifying a situation in which a flow of advertising contents is controlled on the basis of the video chat according to one embodiment of the present invention.

FIG. 4 depicts diagrams exemplifying user interfaces provided to a talker device according to one embodiment of the present invention.

FIG. 5 depicts a diagram exemplifying a user interfaces provided to a talker device according to one embodiment of the present invention.

### DETAILED DESCRIPTION OF EXEMPLARY EMBODIMENTS

In the following detailed description, reference is made to the accompanying drawings that illustrates, by way of illustration, specific embodiments in which the present invention may be practiced. These embodiments are described in sufficient detail to enable those skilled in the art to practice the present invention. It should be understood that various embodiments of the present invention, although different, are not necessarily mutually exclusive. For example, specific forms, structures, and characteristics described herein may be implemented by being altered from one embodiment to another embodiment without departing from the spirit and scope of the present invention. Further, it should be understood that positions or arrangement of individual elements within each embodiment may also be modified without departing from the spirit and scope of the present invention. Accordingly, the following detailed description is not to be taken in a limiting sense, and the scope of the present invention should be construed to include the scope of the appended claims and equivalents thereof. In the drawings, like numerals refer to the same or similar components throughout various aspects.

Hereinafter, exemplary embodiments of the present invention will be described in detail with reference to the accompanying drawings so as to enable those skilled in the art to which the present invention pertains to practice the present invention.

In this disclosure, a content is a concept that collectively refers to digital information or individual information elements configured with characters, symbols, voices, sounds, images, moving images, and the like. For example, such a content may be configured to include pieces of data, such as texts, images, moving pictures, audios, and links (e.g., web links), or a combination of at least two of the pieces of data.

Configuration of Overall System

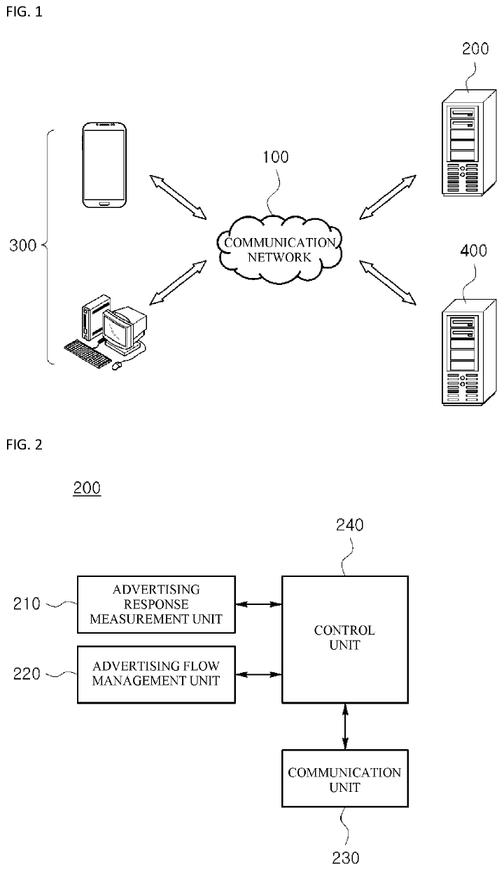

FIG. 1 is a diagram illustrating a schematic configuration of an overall system for controlling a flow of advertising contents on the basis of a video chat according to one embodiment of the present invention.

As shown in FIG. 1, the overall system according to one embodiment of the present invention may include a communication network 100, an advertising flow control system 200, a talker device 300, and a video chat service providing system 400.

First, the communication network 100 according to one embodiment of the present invention may be configured without regard to a communication aspect such as wired communication or wireless communication and may be configured with various communication networks such as a local area network (LAN), a metropolitan area network (MAN), a wide area network (WAN), and the like. Preferably, the communication network 100 referred to herein may be the known Internet or World Wide Web (WWW). However, the communication network 100 is not limited thereto and may include, at least in part, a known wired or wireless data communication network, a known telephone network, or a known wired or wireless television network.

For example, the communication network 100 may be a wireless data communication network which is, at least in part, implementation of a conventional communication method such as a wireless fidelity (WiFi) communication method, a WiFi-Direct communication method, a long term evolution (LTE) communication method, a Bluetooth communication method (e.g., a Bluetooth low energy (BLE) communication method), an infrared communication method, an ultrasonic communication method, and the like.

Next, the advertising flow control system 200 according to one embodiment of the present invention may communicate with the talker device 300 and the video chat service providing system 400, which will be described below, through the communication network 100, and the advertising flow control system 200 may perform a function of measuring a positive response level of at least one talker among two or more talkers about advertising contents being provided to the two or more talkers on the basis of information on interaction between the two or more talkers participating in a video chat and dynamically controlling a flow of advertising contents, which will be provided to the at least one talker, on the basis of the measured positive response level.

A configuration and a function of the advertising flow control system 200 according to the present invention will be provided in detail through the following detailed description. While the advertising flow control system 200 has been described as above, this description is illustrative, and it will be obvious to those skilled in the art that at least some of functions or components required for the advertising flow control system 200 may be implemented, if necessary, in the talker device 300, the video chat service providing system 400, or an external system (not shown) or may be included, if necessary, in the talker device 300, the video chat service providing system 400, or the external system.

Next, according to one embodiment of the present invention, the talker device 300 is a digital device including a function capable of accessing and communicating with the advertising flow control system 200 and the video chat service providing system 400 through the communication network 100, and any digital device may be adopted as the talker device 300 as long as it includes a memory part, such as a smart phone, a notebook, a desktop, a tablet personal computer (PC), and the like, and has a computing ability by embedding a microprocessor. Further, according to one embodiment of the present invention, the talker device 300 may further include a camera module (not shown) for using the above-described video chat service or acquiring a facial expression and gaze information of the talker.

Meanwhile, according to one embodiment of the present invention, the talker device 300 may include an application for supporting a function, according to the present invention, for controlling a flow of advertising contents on the basis of a video chat. Such an application may be downloaded from the advertising flow control system 200 or an external application distribution server (not shown).

Next, the video chat service providing system 400 according to one embodiment of the present invention may be a system for providing a chat service, which is capable of communicating with the advertising flow control system 200 and the talker device 300 through the communication network 100 and allowing transmission and reception of a chat on the basis of at least one of a video, a voice, and a text of at least one talker (i.e., at least one talker device 300). For example, the above-described video chat service may a service including at least a part of features or attributes of various known video chat services such as Duo (Google), Airlive (Air Live Korea), Houseparty (Life on Air), and the like.

Configuration of Advertising Flow Control System

Hereinafter, an internal configuration and each component of the advertising flow control system 200 performing an important function for implementing the present invention will be described.

FIG. 2 is a detailed diagram illustrating an internal configuration of the advertising flow control system 200 according to one embodiment of the present invention.

The advertising flow control system 200 according to one embodiment of the present invention may be a digital device including a memory unit and having a computing ability by embedding a microprocessor. The advertising flow control system 200 may be a server system. As shown in FIG. 2, the advertising flow control system 200 may include an advertising response measurement unit 210, an advertising flow management unit 220, a communication unit 230, and a control unit 240. According to one embodiment of the present invention, at least some of the advertising response measurement unit 210, the advertising flow management unit 220, the communication unit 230, and the control unit 240 of the advertising flow control system 200 may be a program module communicating with an external system. Such a program module may be included in the advertising flow control system 200 in the form of an operating system, an application program module, or other program module and may be physically stored in various known storage devices. Further, the program module may be stored in a remote storage device capable of communicating with the advertising flow control system 200. Alternatively, the program module collectively includes, according to the present invention, a routine, a subroutine, program, an object, a component, a data structure, and the like which perform a specific task or a specific abstract data type, which will be described below, but the present invention not limited thereto.

First, the advertising response measurement unit 210 according to one embodiment of the present invention may perform a function of measuring a positive response level of at least one talker among two or more talkers about advertising contents being provided the two or more talkers on the basis of information on interaction among the two or more talkers participating in a video chat. According to one embodiment of the present invention, the two or more talkers receiving the advertising contents may mean talkers who are present (or participate) in the same group (e.g., the same chat room) among video chat groups configured by the two or more talkers in the video chat. According to one embodiment of the present invention, the information on the interaction among the two or more talkers may include at least one of a facial expression, chat contents, voice, and biological signals (e.g., brainwave, a body temperature, a pulse rate, a heart rate, and the like) of at least one talker.

Specifically, the advertising response measurement unit 210 according to one embodiment of the present invention may measure a positive response level of the at least one talker about the advertising contents by analyzing the information on the interaction represented by the two or more talkers while the advertising contents are being provided to the two or more talkers participating in the video chat. According to one embodiment of the present invention, such positive response levels may be classified into various groups according to a predetermined criteria. For example, the positive response levels may be variously classified according to a predetermined criteria such as a “high” and “low” positive response level dichotomy, or a “high,” “low,” and “no” positive response level trichotomy.

For example, according to one embodiment of the present invention, while two or more talkers participating in a video chat are receiving advertising contents, the two or more talkers may transmit and receive chat contents including favorable and unfavorable comments about the advertising contents, and while watching the advertising contents, the two or more talkers may express various facial expressions such as pleasure, joy, irritability, unpleasantness, and indifference. In this case, the advertising response measurement unit 210 according to one embodiment of the present invention may measure a positive response level of at least one talker on the basis of the chat contents and the facial expressions as information on interaction. More specifically, the advertising response measurement unit 210 according to one embodiment of the present invention may measure a positive response level of a talker about advertising contents by estimating an emotion of the talker about the advertising contents from a facial expression and chat contents of the talker and analyzing the estimated emotion and a phrase or context of the chat contents.

Alternatively, according to one embodiment of the present invention, while two or more talkers participating in a video chat are receiving advertising contents, the two or more talkers may perform voice conversations including favorable and unfavorable comments about the advertising contents, and thus biological signals (e.g., a heart rate, a pulse rate, and the like) may be varied due to excitement, unpleasantness, or the like caused by the advertising contents. In this case, the advertising response measurement unit 210 according to one embodiment of the present invention may measure a positive response level of at least one talker on the basis of the voice conversations and the biological signals as information on interaction. More specifically, the advertising response measurement unit 210 according to one embodiment of the present invention may measure the positive response level of the at least one talker about the advertising contents by comparing and analyzing a pattern of at least one parameter variation (e.g., a variation in voice frequency, amplitude, heart rate, pulse rate, or the like) with a predetermined pattern.

Alternatively, in measuring of the positive response level of the at least one talker about the advertising contents, the advertising response measurement unit 210 according to one embodiment of the present invention may measure the positive response level on the basis of playback sections or playback frames of the advertising contents.

For example, according to one embodiment of the present invention, a talker may have different positive response levels for each playback section or each playback frame while the advertising contents are played back, and thus the advertising response measurement unit 210 may measure the positive response level of the talker for a predetermined playback section (e.g., every 5 seconds) or a predetermined playback frame. In this case, the advertising response measurement unit 210 according to one embodiment of the present invention may determine the positive response level of the talker about the advertising contents on the basis of a frequency of the measured plurality of positive response levels (i.e., the positive response level of the talker for each playback section or each playback frame).

Next, according to one embodiment of the present invention, the advertising flow management unit 220 may perform a function of dynamically controlling a flow of advertising contents, which will be provided to at least one talker, on the basis of a positive response level measured by the advertising response measurement unit 210. According to one embodiment of the present invention, the flow of the advertising contents may be a concept including a flow relating to determining a second advertising content which will be provided after a first advertising content being provided to the talker as well as a flow relating to whether provision of the first advertising content is stopped or a point of time for switching from the first advertising content to the second advertising content.

Specifically, according to one embodiment of the present invention, the advertising flow management unit 220 may determine at least one among a content, a type, and an attribute of an advertising content which will be provided after the advertising content being currently provided to a talker or may determine whether to stop or switch the advertising content being currently provided to the talker on the basis of the positive response level measured by the advertising response measurement unit 210. According to one embodiment of the present invention, the attribute of the advertising content may be a concept including at least one among a size of the advertising content (specifically, a size on the talker device 300), a position of the advertising content (specifically, a position on the talker device 300), a playback time of the advertising content, a playback section of the advertising content, and whether a call to action (CTA) is included, and the type of the advertising content may be a concept including at least one among an image, a text, voice, and a video.

For example, according to one embodiment of the present invention, when the positive response level is above a predetermined level, the advertising flow management unit 220 may provide the talker with an advertising content, which will be provided to two or more talkers after the advertising content being currently provided thereto, having at least one among a type, a category of business, an advertiser, a product, and a service the same as or similar to those of the advertising content being currently provided to the two or more talkers.

Alternatively, according to one embodiment of the present invention, when the positive response level is above a predetermined level, the advertising flow management unit 220 may provide an advertising content including a CTA after the advertising content being currently provided to a talker in order to derive a specific action of the talker on the advertising content being currently provided to the talker. That is, according to one embodiment of the present invention, in addition to simply providing the advertising content, an advertising content including a CTA is additionally provided to a talker having a positive response level over a predetermined level, so that an advertisement effect can be doubly enhanced.

Further alternatively, according to one embodiment of the present invention, when the positive response level is below a predetermined level, the advertisement flow management unit 220 may suspend the provision of the advertising content being currently provided to two or more talkers or may switch the advertising content to another advertising content. That is, according to one embodiment of the present invention, when the positive response level of the talker about the advertising content is below a predetermined level, another advertising content may be provided without any additional effort of the talker, so that an advertising content having a higher advertisement effect may be provided to the talker.

Meanwhile, when a measured positive response level of at least one talker receiving an advertising content is above a predetermined level, the advertising flow management unit 220 according to one embodiment of the present invention may primarily provide the advertising content to the at least one talker when the at least one talker performs a video chat with other talkers.

For example, when a measured positive response level of a talker receiving an advertising content is above a predetermined level, the advertising flow management unit 220 according to one embodiment of the present invention may provide the advertising content in preference to other advertising contents when the talker performs a video chat in other chat group (or other chat room). That is, according to one embodiment of the present invention, when a first talker having a positive response level above a predetermined level about a certain advertising content performs a video chat in other chat group (or other chat room), a positive or friendly probability of the first talker about the certain advertising content may increase when the certain advertising content is primarily provided, so that the first talker may aggressively act as a honorary ambassador and thus advertisement effect can be maximized.

Alternatively, the advertising flow management unit 220 according to one embodiment of the present invention may further refer to at least one among personal information of a talker, a social network service (SNS) relating to the talker, and information (e.g., call history, messages, schedules, and Internet cookie information) stored in a talker device in order to control a flow of advertising contents.

Next, the communication unit 230 according to one embodiment of the present invention performs a function of allowing data transmission and reception from and to the advertising response measurement unit 210 and the advertising flow management unit 220.

Finally, the control unit 240 according to one embodiment of the present invention performs a function of controlling a flow of pieces of data between the advertising response measurement unit 210, the advertising flow management unit 220, and the communication unit 230. That is, the control unit 240 according to the present invention may control each of the advertising response measurement unit 210, the advertising flow management unit 220, and the communication unit 230 to perform a specific function by controlling the flow of the pieces of data from and to the outside of the advertising flow control system 200 or between the components of the advertising flow control system 200.

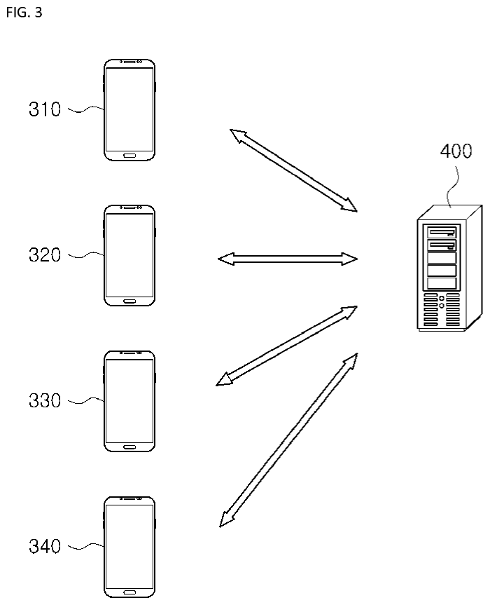

FIG. 3 is a diagram exemplifying a situation in which a flow of advertising contents is controlled on the basis of the video chat according to one embodiment of the present invention.

Referring to FIG. 3, it can be assumed that the advertising flow control system 200 according to one embodiment of the present invention is included in the video chat service providing system 400 according to the present invention.

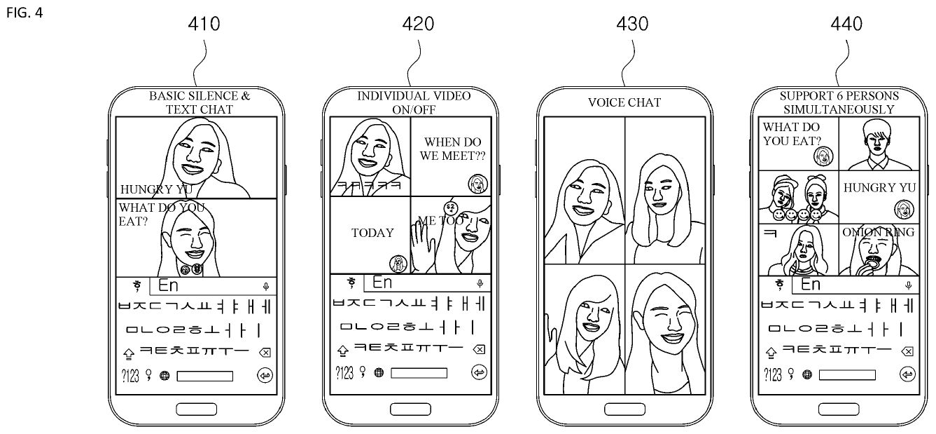

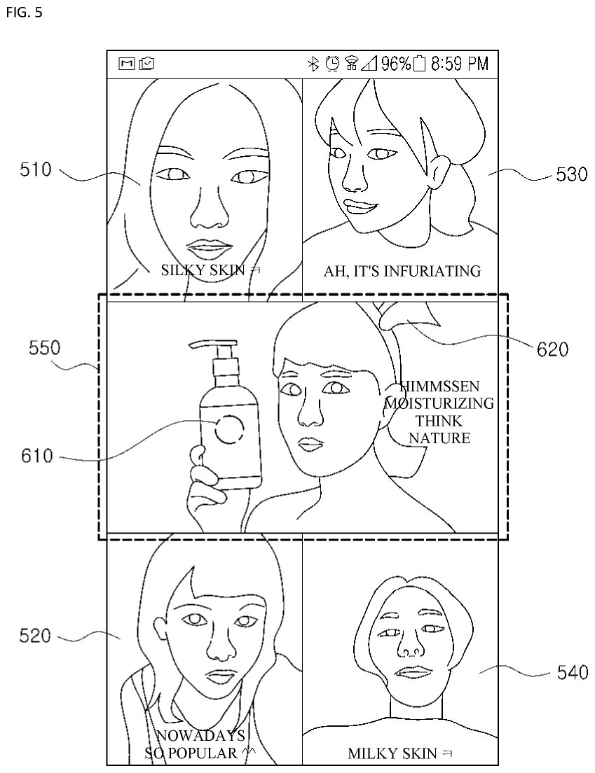

FIGS. 4 and 5 are diagrams exemplifying user interfaces provided to the talker devices 310, 320, 330, and 340 according to one embodiment of the present invention.

According to one embodiment of the present invention, a video chat service may be provided to talker devices 310, 320, 330, and 340 through the video chat service providing system 400, and the video chat service may be a service of allowing two or more talkers to transmit and receive chats among the two or more talkers using at least one of images, voices, and texts.

For example, in accordance with one embodiment of the present invention, the video chat service may be provided as only images and characters 410 without voices, or as only images and voices 430 according to a setting of the talker. Further, according to one embodiment of the present invention, the video chat service may turn on or off an image 420, which is provided to another talker, according to the setting of the talker.

Meanwhile, according to one embodiment of the present invention, a screen 440 provided on each of the talker devices 310, 320, 330, and 340 may be symmetrically or asymmetrically divided on the basis of the number of participants who participate in the video chat service.

First, the video chat service providing system 400 according to one embodiment of the present invention may determine an advertising content 550 which will be provided to four talkers 510, 520, 530, and 540 (a first talker 510, a second talker 520, a third talker 530, and a fourth talker 540) on the basis of facial expressions and chat contents of the four talkers 510, 520, 530, and 540. More specifically, according to one embodiment of the present invention, the video chat service providing system 400 may estimate all the facial expressions of the four talkers 510, 520, 530, and 540 as a “joyful” state by analyzing the facial expressions and the chat contents of the four talkers 510, 520, 530, and 540 and the chat contents transmitted and received among the four talkers 510, 520, 530, and 540, and the video chat service providing system 400 may determine an advertising content relating to the estimated state and the chat contents on a skin moisturization among the four talkers 510, 520, 530, and 540 as the advertising content 550 which will be provided to the four talkers 510, 520, 530, and 540.

Then, according to one embodiment of the present invention, the determined advertising content 550 may be provided to the four talkers 510, 520, 530, and 540 at the same point of time. That is, the same advertising content is provided to the talkers 510, 520, 530, and 540 at the same point of time, so that contents relating to the advertising content may be a common chat theme among the talkers 510, 520, 530, and 540, and thus the talker 510, 520, 530, and 540 may naturally share thoughts (e.g., unfavorable and favorable comments and the like) about the advertising content.

Meanwhile, a position, a size, or an arrangement of the advertising content 550 on the screen of each of the talker devices 310, 320, 330, and 340 may be dynamically changed by being interlocked with the number of chat participants and the like.

Next, according to one embodiment of the present invention, a positive response level of each of the four talkers 510, 520, 530, and 540 about the advertising content 550 may be measured on the basis of the facial expressions and the chat contents of the four talkers 510, 520, 530, and 540 (i.e., an example of the information on the interaction). According to one embodiment of the invention, these positive response levels (e.g., in this case, the positive response level about the advertising content 550 may be discriminated into “high” and “low”) may be estimated such that the first talker 510 is “low,” the second talker 520 is “high,” the third talker 530 is “high,” and the fourth talker 540 is “high.”

Thereafter, the flow of advertising contents, which will be provided to the talkers 510, 520, 530, 540, may be dynamically controlled on the basis of the positive response levels.

More specifically, according to one embodiment of the present invention, when the positive response level of the majority of talkers are is “high” (i.e., when the positive response level is above a predetermined level), a detailed introduce video of a product relating to the advertising content, an event video of the product, a video of the product including a purchase of the product and a CTA for participation in an event may be provided after the advertising content being currently provided (i.e., an advertising content relating to “skin moisturization”).

That is, according to one embodiment of the present invention, through the advertising flow control system 200 according to the present invention, the flow of the advertising contents may be controlled by talkers who naturally talk to each other without an effort such as clicking a button or making a comment so as to express opinions, and thus the advertisement charging method such as a cost per click (CPC) or a cost per action (CPA) may be efficiently performed.

Meanwhile, according to one embodiment of the present invention, when the positive response level of each of the four talkers 510, 520, 530, and 540 about the advertising content 550 is such that the first talker 510 is “low′” the second talker 520 is “low,” the third talker 530 is “low,” and the fourth talker 540 is “high,” and thus an average positive response level is less than 25% (i.e., when the average positive response level is below a predetermined level), the provision of the advertising content for “skin moisturization” may be suspended and other advertising contents may be provided.

In accordance with the present invention, it is possible to control a flow of advertising contents by simply allowing talkers to naturally chat to each other without clicking or typing of the talkers.

Further, in accordance with the present invention, the flow of the advertising contents is dynamically controlled on the basis of information on interaction between the talkers, so that advertising efficiency and effect can be maximized.

Furthermore, in accordance with the present invention, a facial expression or chat content of the talker is naturally acquired during the video chat, so that repulsion or a privacy problem for image acquisition can be resolved.

The above-described embodiments according to the present invention may be implemented in the form of a program command which is executable through various computer components and may be recorded in a computer-readable recording medium. The computer-readable recording medium may include program commands, data files, data structures, and the like in alone or a combination thereof. The program commands recorded in the computer-readable recording medium may be specially designed and configured for the present invention or may be available to those skilled in the computer software. Examples of the computer-readable recording media include magnetic media such as a hard disk, a floppy disk, and a magnetic tape, optical recording media such as a compact disc read only memory (CD-ROM) and a digital versatile disc (DVD), a magneto-optical medium such as a floptical disk, medium, and hardware devices specifically configured to store and execute program commands, such as a read only memory (ROM), a random access memory (RAM), a flash memory, and the like. Examples of the program commands include machine language codes generated by a compiler, as well as high-level language codes which are executable by a computer using an interpreter or the like. The hardware devices may be modified as one or more software modules so as to perform an operation of the present invention, and vice versa.

While the present invention has been described with reference to specific items such as particular components, exemplary embodiments, and drawings, these are merely provided to help understanding the present invention, and the present invention is not limited to these embodiments, and those skilled in the art to which the present invention pertains can variously alter and modify from the description of the present invention.

Therefore, the spirit of the present invention should not be limited to the above-described embodiments, and it should be construed that the appended claims as well as all equivalents or equivalent modifications of the appended claims will fall within the scope of the present invention.

What is claimed is:

1. A method for controlling a flow of advertising contents on the basis of a video chat, the method comprising:
measuring a positive response level of at least one talker among two or more talkers about an advertising content being provided to the two or more talkers on the basis of information on interaction among the two or more talkers participating in a video chat; and
dynamically controlling a flow of advertising contents to be provided to the at least one talker on the basis of the positive response level.

2. The method of claim 1, wherein, in the measuring, the information on the interaction includes information on a facial expression and chat contents of the at least one talker.

3. The method of claim 1, wherein the measuring includes determining the advertising content on the basis of at least one of the facial expression and the chat contents.

4. The method of claim 1, wherein, when the positive response level is above a predetermined level, after the advertising content being currently provided, the controlling includes providing an advertising content having at least one among a type, a category of business, an advertiser, a product, and a service the same as or similar to those of the advertising content being currently provided.

5. The method of claim 1, wherein, when the positive response level is above a predetermined level, the controlling includes primarily providing the advertising content being currently provided while the at least one talker performs a video chat with other talkers.

6. The method of claim 1, wherein, when the positive response level is below a predetermined level, the controlling includes suspending the provision of the advertising content or switching from the advertising content to another advertising content.

7. The method of claim 1, wherein the controlling includes determining at least one among a content, a type, and an attribute of an advertising content to be provided after the advertising content on the basis of the positive response level.

8. A non-transitory computer-readable recording medium for recording a computer program for performing the method according to claim 1.

9. A system for controlling a flow of advertising contents on the basis of a video chat, the system comprising:
an advertising response measurement unit configured to measure a positive response level of at least one talker among two or more talkers about an advertising content being provided to the two or more talkers on the basis of information on interaction among the two or more talkers participating in a video chat; and
an advertising flow management unit configured to dynamically control a flow of advertising contents to be provided to the at least one talker on the basis of the positive response level.
